(19) United States
(12) Patent Application Publication
(10) Pub. No.: US 2020/0097087 A1
(43) Pub. Date: Mar. 26, 2020

(54) FORCE FEEDBACK METHOD AND SYSTEM

(71) Applicant: REALGAM CO., LTD., Seongnam-Si, Gyeonggi-do (KR)

(72) Inventors: Bok Sung Oh, Anyang-Si (KR); Yun Ho Lee, Anyang-Si (KR); Yon Woo Chung, Seoul (KR)

(73) Assignee: REALGAM CO., LTD., Seongnam-Si, Gyeonggi-do (KR)

(21) Appl. No.: 16/311,033

(22) PCT Filed: Nov. 2, 2018
(86) PCT No.: PCT/KR2018/013222

§ 371 Date: Dec. 18, 2018

(30) Foreign Application Priority Data
Sep. 20, 2018 (KR) 10-2018-0112551

(51) Int. Cl. G06F 3/01; G06F 3/00

(52) U.S. Cl. CPC G06F 3/016; G06F 3/002

(57) ABSTRACT

Disclosed is a force feedback method. The force feedback method includes detecting occurrence of a contact event that a virtual user object contacts a single virtual object; setting a writing pressure of a user object in the contact event; and setting a force feedback control variable based on the writing pressure.

### TECHNICAL FIELD

An example embodiment relates to a force feedback method, and more particularly, to a force feedback method and system that may provide force feedback for a writing pressure detected in response to a user object moving in contact with a virtual object.

### RELATED ART

Techniques related to augmented reality, mixed reality, and virtual related are rapidly developing in relation to the fourth industrial revolution. Such augmented reality, mixed reality, and virtual reality are attempting to expand a sense of reality beyond time and space. Accordingly, such technologies are collectively referred to as extended reality.

In general, the extended reality technology is used in a computing system in the fields of education, entertainment, training, and medicine. In particular, the extended reality technology is regarded as an alternative capable of enhancing the sense of reality that is limited in an existing game through combination with the game and is also attracting attention due to the effect as if a user experiences the game.

To add a sense of immersion to the game based on the extended reality technology, a force feedback providing controller that realistically transfers a physical change in an image, such as a collision and a positional change, to a user is being developed. Many controllers according to the related art use a method of applying a vibration. Currently, due to some limitations found in force feedback by vibration, a kinesthetic force feedback system that provides a direct force to the user is being developed. In the related art, many controllers use the method of applying a vibration. However, currently, the kinesthetic force feedback is in development to provide a direct force to the user to overcome the limit found in vibration haptic feedback.

Many force feedback systems generate force feedback suitable for a specific event through a manual task and, in response to occurrence of an event in a game, calls and executes a corresponding library. Accordingly, the force feedback systems may provide only a tactile sense by a direct contact or force feedback for a collision that is a physical change, and may not readily implement force feedback that is controlled to be suitable for each situation.

In particular, realistic representations are gradually increasing in a game and a variety of force feedback needs to be implemented in the same event, which may not be readily achieved with current technology.

### DETAILED DESCRIPTION

### Objectives

An example embodiment provides a force feedback method and system that may generate a force feedback control signal based on a physical control factor of an object and may provide kinesthesia to enhance a sense of reality and a sense of immersion in extended reality.

Also, an example embodiment provides a force feedback method and system that may provide a user with a writing pressure occurring in response to a contact event between a user object and a virtual object in an environment using extended reality, such that the user may actually experience a sense of contact in an extended reality environment.

Objectives to be solved in example embodiments are not limited thereto and other objectives not described herein may be clearly understood by those skilled in the art from the following description.

### Solutions

A force feedback method according to an example embodiment is described.

According to an aspect, there is provided a force feedback method including detecting occurrence of a contact event that a user object contacts a virtual object; changing a force feedback control variable in response to the user object moving in the contact event; and providing force feedback based on the changed control variable.

According to another aspect, there is provided a force feedback method including detecting occurrence of a contact event that a user object including a virtual substance contacts a virtual object based on the virtual substance present therebetween; changing a force feedback control variable in response to the user object moving in the contact event; and providing force feedback based on the changed control variable.

According to another aspect, there is provided a non-transitory computer-readable storage medium recording a program to implement a force feedback method.

According to another aspect, there is provided a force feedback system including a control apparatus configured to detect occurrence of a contact event that a user object contacts a virtual object, and to generate a force feedback control signal for a writing pressure by changing the force feedback control variable in response to movement of the user object; and an output apparatus configured to receive the force feedback control signal and to provide a user with a sense for the writing pressure.

### Effect

According to example embodiments, it is possible to further enhance a sense of reality and a sense of immersion in an extended reality environment by generating a force feedback control signal based on a physical control factor of an object and by providing a user with kinesthesia to enhance the sense of reality and the sense of immersion in extended reality.

Also, according to example embodiments, since a writing pressure by a contact event between a user object and a virtual object in an environment using extended reality is provided to a user, the user may actually experience a sense of contact in an extended reality environment.

The effects of the force feedback method and system according to the example embodiments are not limited thereto and other effects not described herein may be clearly understood by those skilled in the art from the following description.

### BRIEF DESCRIPTION OF DRAWINGS

FIG. 1 is a diagram illustrating a force feedback system according to an example embodiment.

FIG. 2 is a diagram illustrating a control apparatus according to an example embodiment.

FIG. 3A illustrates an example of a contact event between a user object and a virtual object according to an example embodiment.

FIG. 3B is a graph showing a change in a pressing force of a user object over time when the user object moves at the same rate in contact according to an example embodiment.

FIG. 3C illustrates an example of a change in a contact area displayed through a contact of FIG. 3A.

FIG. 4A illustrates an example in which a user object moves from one virtual object V1 to another virtual object V2 having a relatively great friction coefficient according to an example embodiment.

FIG. 4B is a graph showing a change in a magnitude of writing force over time when the user object moves in FIG. 4A.

FIG. 4C illustrates an example in which a user object moves from one virtual object V1 to another virtual object V3 having a relatively small friction coefficient.

FIG. 4D is a graph showing a change in a magnitude of writing pressure over time when the user object moves in FIG. 4C.

FIG. 5 is a flowchart illustrating a force feedback method according to an example embodiment.

FIG. 6 is a flowchart illustrating a force feedback method according to another example embodiment.

The following drawings attached herein provide the example embodiments and are provided to simply make the technical spirit of the disclosure further understandable with the detailed description and accordingly, should not limit or restrict the present disclosure.

### BEST MODE

Hereinafter, some example embodiments will be described in detail with reference to the accompanying drawings. Regarding reference numerals assigned to elements in the drawings, it should be noted that the same elements will be designated by the same reference numerals, wherever possible, even though they are shown in different drawings. Also, in the description of example embodiments, detailed description of well-known related structures or functions will be omitted when it is deemed that such description will cause ambiguous interpretation of the present disclosure.

Terms, such as first, second, A, B, (a), (b), and the like, may be used herein to describe components. Each of these terminologies is not used to define an essence, order or sequence of a corresponding component but used merely to distinguish the corresponding component from other components. It should be noted that if it is described that one component is “connected”, “coupled”, or “joined” to another component, a third component may be “connected”, “coupled”, and “joined” between the first and second components, although the first component may be directly connected, coupled, or joined to the second component.

A component included in a single example embodiment and a component including a common function are described using the same name in another example embodiment. Unless described otherwise, description made in one example embodiment may be applicable to the other example embodiment and a detailed description in the repeated range is omitted.

Prior to describing the example embodiment, the term “user object U” refers to a user manipulatable tool, such as a pen, a brush, a pencil, a knife, etc., that is moved with being gripped or worn on extended reality in response to an input of a user.

Also, the term “virtual object V” refers to a virtual object, such as paper, cloth, or wall, in the extended reality, the user is incapable of manipulating, however, that is contactable with the user object U. Also, a virtual substance S refers to a substance provided between the user object U and the virtual object V, such as water, ink, paint, a painting material, jam, butter, pencil lead, and eraser, between the user object U and the virtual object V in an extended reality environment. The virtual substance S is provided on the user object U and gradually comes off from the user object U by a contact between the user object U and the virtual object V.

Here, the virtual object V and the virtual substance S may be a virtual object or a real object in the extended reality.

When the user object U is configured as a virtual object, the user object U may be configured as the virtual substance S itself. For example, the user object U may be a virtual substance, such as a crayon, a pastel, and a chalk.

The extended reality collectively refers to augmented reality, mixed reality, and virtual reality.

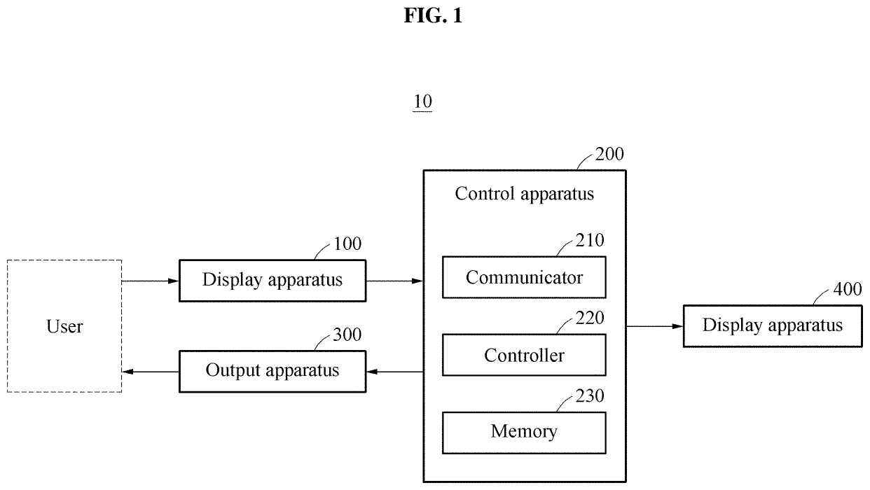

FIG. 1 is a diagram illustrating a force feedback system according to an example embodiment.

Referring to FIG. 1, a force feedback system 10 includes an input apparatus 100, a control apparatus 200, an output apparatus 300, and a display apparatus 400. Although not illustrated, the force feedback system 10 may further include a camera and a microphone.

The input apparatus 100 may refer to an apparatus configured to receive information on a location, a direction, an acceleration, a pressure, and a key corresponding to an input of a user and to generate input data. The input apparatus 100 may be an apparatus that includes a gyro sensor, an encoder, a touch panel, and a keypad with a plurality of key buttons, and is configured to detect the input of the user and generate the input data. For example, the input apparatus 100 may be a game pad, a paddle controller, a trackball, a joystick, an arcade style joystick, a vehicle handle, a mouse, and a data glove. Also, the input apparatus 100 may be configured as, for example, a camera and a motion sensor, configured to detect a motion such as a hand motion and an arm motion of the user and to recognize the motion as the input of the user.

The control apparatus 200 detects a contact event that a user object U contacts a virtual object V, changes a force feedback control variable in response to movement of the user object U, and generates a force feedback control signal for writing pressure. The control apparatus 200 may be an apparatus that includes a storage medium in which a physical engine configured to generate and provide an extended reality environment is recorded. For example, the control apparatus 200 may be a computer, a portable communication terminal such as a cellular phone, a console, a personal digital assistant (PDA), a tablet personal computer (PC), and a server, including a storage medium in which a physical engine is recorded. The control apparatus 200 includes a communicator 210, a controller 220, and a memory 230.

The communicator 210 may transmit and receive input data, a force feedback control signal, image data, and audio data through communication with the input apparatus 100, the output apparatus 300, or the display apparatus 400. The communicator 210 may communicate with the input apparatus 100, the output apparatus 300, or the display apparatus 400 in a wired manner using, for example, a local area network (LAN) and a data cable, or in a wireless manner using, for example, radio frequency (RF) communication, wireless fidelity (WiFi), long term evolution (LTE), Bluetooth, infrared data association (IrDA), ZigBee, ultrawideband (UWB), code division multiple access (CDMA), frequency division multiplexing (FDM), and time division multiplexing (TDM). Also, the communicator may communicate with the input apparatus 100, the output apparatus 300, or the display apparatus 400 by connecting to the Internet.

Here, the input apparatus 100, the output apparatus 300, or the display apparatus 400 may include a communication module (not shown) capable of communicating with the communicator 210. The communication module may communicate with the communicator 210 in the same manner or may connect thereto through the Internet.

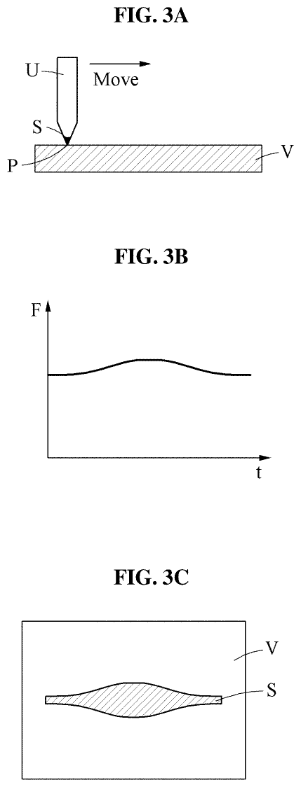

The controller 220 executes a program or an application of providing an extended reality environment, such as a game, in response to a selection of the user, detects the contact event and changes a force feedback control variable on the extended reality environment, and generates a force feedback control signal according thereto. Further description related to the controller 220 will be made with reference to FIGS. 3A to 3C.

The memory 230 may store applications of various functions such as a game and a communication, images for providing graphical user interfaces (GUIs) associated therewith, user information, document related databases, background images, for example, a menu screen and an idle screen, or operation programs required to operate the force feedback system, and the like. Also, the memory 230 may store data of a force feedback control variable corresponding to each of control factors.

Here, the contact event indicates an event of a situation in which the user object U and the virtual object V are in contact with each other. For example, the contact event refers to an event that the user object U and the virtual object V contact at a single contact point on the extended reality. Here, the user object U may directly contact the virtual object V, or may contact the virtual object V based on a virtual substance provided between the user object U and the virtual object V.

For example, the user object U may be configured as a virtual substance itself such as charcoal, crayon, eraser, and pastel. For example, the user object U may be a ball pen, a brush, or a pencil to which a virtual substance S is provided and comes off at an end of the user object, or a knife with butter or jam.

Also, the control factor refers to a physical factor used to configure the user object, the virtual object, and the contact event, and refers to a physical factor such as a magnitude of force, a contact angle, a contact area, a defect of a virtual object surface, a stiffness, a friction coefficient, and a viscosity.

The force feedback control variable refers to a variable for providing force feedback. For example, in the case of a force feedback control through an impedance control, the force feedback control variable may be a mass constant m, an attenuation constant c, or a spring constant k.

The output apparatus 300 receives the force feedback control signal, outputs a sense for writing pressure through a vibration or kinesthesia, and provides the output sense to the user. The output apparatus 300 may be a vibration-type output apparatus that provides a vibration or a kinesthesia-type output apparatus that provides a physical force. Here, the output apparatus 300 may be the kinesthesia-type output apparatus that provides the physical force.

Also, desirably, the output apparatus 300 may be an output apparatus that may output a delicate change in force through freewheeling in which load by a motor is absent since the output apparatus 300 includes a clutch of the kinesthesia-type output apparatus and a connection to a driving portion such as the motor is completely blocked. If the kinesthesia-type output apparatus capable of performing freewheeling may be configured in three states, for example, a load state of an output shaft by an operation of the motor, a no-load state by a magnetic field of the motor through connection between the output shaft and the motor, and a freewheeling state, it may be the most desirable form.

Although the input apparatus 100 and the output apparatus 300 are illustrated to be separate herein, it is provided as an example only for clarity of description. The input apparatus 100 and the output apparatus 300 may be provided in an integrated form and input and output may be performed in a single apparatus.

The display apparatus 400 displays the image data and the audio data received from the control apparatus 200 for the user. For example, the display apparatus 400 may be a TV including a display and a speaker, a monitor, and a head mounted display (hereinafter, a VR headset). The display apparatus 400 may display, for the user, an image updated periodically or in response to an event.

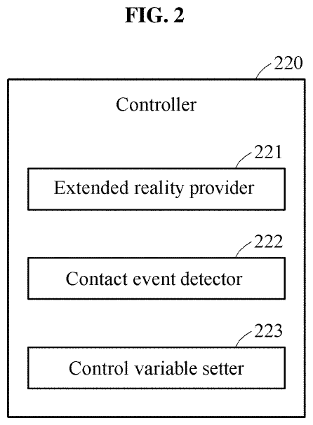

FIG. 2 is a diagram illustrating a control apparatus according to an example embodiment.

Referring to FIG. 2, the controller 220 includes an extended reality provider 221, a contact event detector 222, and a control variable setter 223.

The extended reality provider 221 configures extended reality including user object data and virtual object data. For example, the extended reality provider 221 may generate an extended reality environment by generating a user object U, a virtual object V, and a control factor into data.

The extended reality provider 221 may generate the generated extended reality environment into image data and audio data, and may provide the generated image data and audio data to the display apparatus 400 through the communicator 210, such that the user may receive the same using an image and sound. Also, the extended reality provider 221 may provide the display apparatus with image data and audio data that is updated in response to a contact event in real time.

The user object data refers to data that includes a physical control factor of the user object U in the extended reality. Also, the virtual object data refers to data that includes a physical control factor of the virtual object V in the extended reality. Here, all of the user object U, the virtual substance, and the virtual object V may be configured as virtual objects. At least one thereof may be configured as a hologram or a virtual object in augmented reality or mixed reality.

The contact event detector 222 detects the contact event by determining whether the contact between the user object U and the virtual object V is an instant contact or a continuous contact. For example, when the contact between the user object U and the virtual object V is the continuous contact, the contact event detector 222 detects the corresponding contact as the contact event.

The contact event detector 222 provides, to the control variable setter 223, contact event data that includes a physical control factor for the detected contact event. For example, the contact event detector 222 may detect a contact by a user input of the user object U or a process being executed, or may detect that the user input is an instruction triggering the contact between the user object U and the virtual object V.

The control variable setter 223 receives the contact event data and changes the force feedback control variable. Here, when pressing and thereby moving a writing pressure according to a contact event, that is, moving the user object U in a state in which the user object U is in contact with the virtual object V, the control variable setter 223 changes a force feedback control variable to provide an actual sense of the user perceiving for a repulsion occurring at a contact point by a pressing force and a moving force based on a location of an input apparatus of the user.

FIGS. 3A to 3C illustrate examples of a writing pressure according to an example embodiment.

FIG. 3A illustrates an example of a contact event between a user object and a virtual object according to an example embodiment, FIG. 3B is a graph showing a change in a pressing force of a user object over time when the user object moves at the same rate in contact according to an example embodiment, and FIG. 3C illustrates an example of a change in a contact area displayed through a contact of FIG. 3A.

Referring to FIGS. 3A to 3C, the writing pressure refers to a pressure pressed when a user of a brush or a ball pen moves a user object U being gripped or worn by the user in contact with a virtual object V. A contact area between the user object U and the virtual object V that is contacted and displayed by the writing pressure varies. For example, in the case of brushing while dropping a virtual substance S from the virtual user object U to the virtual user object U using a brush or a pen such as a board marker, if a pressing force increases, a brushing thickness increases. On the contrary, if the pressing force decreases, the brushing thickness decreases. This phenomenon occurs since a shape changes according to stiffnesses of the user object U and the virtual object V by the writing pressure and the contact area varies.

Here, a repulsive force occurs due to the pressing force and the moving force of the user object U. The writing pressure refers to a sense by the repulsive force. The writing pressure varies based on a contact area at the contact point, a friction coefficient, or a viscosity of the virtual substance. In addition, the writing pressure may also vary based on various control factors, such as a contact angle, a stiffness, a surface defect of the virtual substance, and a change in volume of the virtual substance.

Referring again to FIG. 2, the control variable setter 223 extracts physical control factor information from user object data, virtual object data, and contact event data, and changes the force feedback control variable. The control variable setter 223 may change the force feedback control variable based on at least one of control factors including a magnitude of force, a contact angle, a contact area, a defect of a virtual object surface, a stiffness, a friction coefficient, and a viscosity. In detail, the control variable setter 223 may change the force feedback control variable based on at least one of a contact angle between the user object and the virtual object, a contact area between the user object and the virtual object, a contact surface of the virtual substance, a stiffness of the user object, a stiffness of the virtual object, a friction coefficient of the user object, a friction coefficient of the virtual object, a viscosity of the user object, a viscosity of the virtual object, a viscosity of the virtual substance between the user object and the virtual object, and a surface defect of the virtual object.

For example, when a paint is provided as the virtual substance between the user object U and the virtual object V, the control variable setter 223 may change a force feedback control variable based on a viscosity of the paint, a change in volume of the paint, a decrease amount of the contact surface of the paint, and a frictional force. As another example, when the user object U is provided as an eraser and is in contact with the virtual object, the control variable setter 223 may change a force feedback control variable based on a stiffness of the eraser, a frictional force occurring between the eraser and the virtual object, a stiffness of the eraser, and a frictional force occurring between the eraser and the virtual object, a pressing force of the user object, and a change in a contact area.

The control factor may be classified into a static factor and a dynamic factor as a physical variable for generating writing pressure data. The static factor may be an invariable physical control factor including a stiffness of the user object, the virtual object, or the virtual substance, a friction coefficient, a viscosity, and a surface defect of the virtual substance. Also, the dynamic factor may be a variable physical control factor including a pressing force, a contact area, a contact angle, and volume of the virtual substance, which is variable by an input of the user.

The control variable setter 223 changes the force feedback control variable by considering the static factor and the dynamic factor that varies depending on a circumstance. For example, if friction coefficients and viscosities of the user object U, the virtual object V, and the virtual substance S increase, the control variable setter 223 may change the force feedback control variable to increase the writing pressure for movement. Also, if stiffnesses of the user object U, the virtual object V, and the virtual substance increase, the writing pressure setter 223 may change the force feedback control variable to decrease the writing pressure for the pressing force.

The control variable setter 223 changes the force feedback control variable for a pressing force and movement based on a force for pressing the user object, a force for moving the user object, a contact area between the user object U and the virtual object V, and a contact angle. For example, if the pressing force increases, the control variable setter 223 may change the force feedback control variable to increase the writing pressure. Here, the contact area increases due to the pressing force of the user object U. The control variable setter 223 sets writing pressure data by further considering the contact area.

Here, the control variable setter 223 changes the force feedback control variable by further considering the contact angle. For example, if the contact angle between the user object U and the virtual object V varies, the control variable setter 223 changes the force feedback control variable based on a direction in which and an angle at which the writing pressure is applied based on the contact angle, and a change in the contact area occurring due to the contact angle.

The control variable setter 223 may provide a precise writing pressure to the user by setting writing pressure data based on all of the static factor and the dynamic factor, and may provide the writing pressure in real time in response to a change in the input of the user.

The control variable setter 223 sets a control variable for any one of an open loop control method, an ON/OFF control method, a PID control method, and an impedance control method. However, it is provided as an example only. Any method capable of providing a writing pressure may be applied.

For example, the control variable setter 223 changes an impedance control variable based on a magnitude and a direction of writing pressure and a control factor. Here, the impedance control variable may include a spring constant k, a mass constant m, and an attenuation constant c. The control variable setter 224 may determine a writing pressure to be provided to the output apparatus by changing the attenuation constant c based on the friction coefficient or the viscosity or by changing the spring constant k and the mass constant m based on the magnitude and the direction of the writing pressure, and generates a force feedback control signal and provides the generated force feedback control signal to the output apparatus.

Also, the control variable setter 223 may change a control variable to be suitable for each control method. For example, the control variable setter 223 may change a control variable based on a control factor according to a control method of the output apparatus 300. That is, the control variable setter 223 may generate a control signal based on data of the memory according to each of different control methods of the output apparatus 300, and may generate a force feedback control signal for the writing pressure and may provide the generated force feedback control signal.

The control variable setter 223 may provide force feedback to the user through the output apparatus by providing the force feedback control signal to the output apparatus through the communicator.

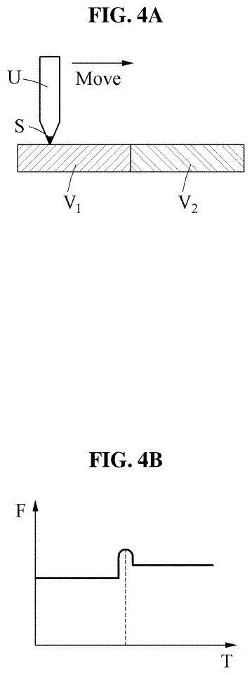

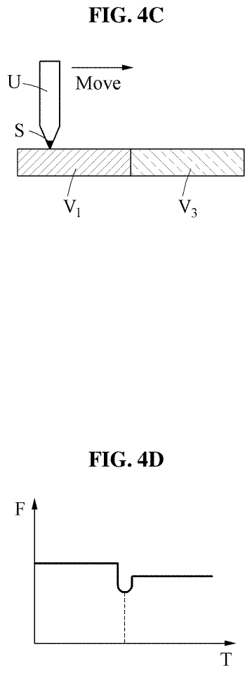

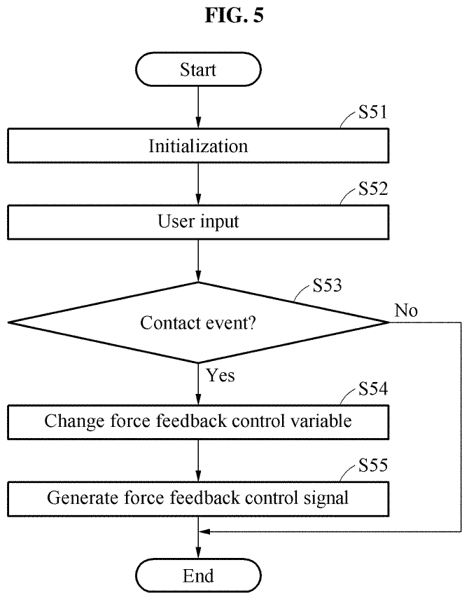

FIGS. 4A to 4D illustrate examples of a force graph over time when a user object moves from one virtual object to another virtual object according to an example embodiment.

Referring to FIGS. 4A to 4D, the control variable setter 223 changes a force feedback control variable when the user object moves from one virtual object to another virtual object. Here, the control variable setter 223 changes the force feedback control variable, such that a magnitude of the writing pressure in a boundary between the one virtual object V1 and the other virtual object V2, V3 instantaneously increases or decreases compared to that of the writing pressure in the other virtual object.

FIG. 4A illustrates an example in which the user object moves from the one virtual object V1 to the other virtual object V2 having a relatively great friction coefficient, and FIG. 4B is a graph showing a change in a magnitude of a writing pressure over time when the user object moves in FIG. 4A.

FIG. 4C illustrates an example in which the user object moves from the one virtual object V1 to the other virtual object V3 having a relatively small friction coefficient, and FIG. 4D is a graph showing a change in a magnitude of a writing pressure over time when the user object moves in FIG. 4C.

Referring to FIGS. 4A and 4B, the control variable setter 223 changes a force feedback control variable to instantaneously increase a writing pressure in a boundary between the one virtual object and the other virtual object compared to a writing pressure in the other virtual object. The other virtual object V2 has a frictional force greater than that of the one virtual object V 1. The control variable setter 223 may instantaneously increase the writing pressure in the boundary and provide kinesthesia according to a change in the writing pressure occurring in the boundary, such that the user may experience a sense of reality.

On the contrary, referring to FIGS. 4C and 4D, the control variable setter 223 may change the force feedback control variable to instantaneously decrease a writing pressure in a boundary between the one virtual object V1 and the other virtual object V3 compared to a writing pressure in the other virtual object V3.

The control variable setter 223 may instantaneously amplify or decrease a writing pressure in a boundary of the virtual object such that the user may certainly recognize a change occurring in the boundary. In response to the change in the boundary, the control variable setter 223 may enhance a sense of reality in the boundary between the one virtual object and the other virtual object.

The controller 220 may generate and provide a force feedback control signal for writing pressure based on a change occurring in a control factor in response to an input of the user, such that the user may realistically feel the writing pressure. Also, the controller 220 may change a control variable based on a real-time change in a contact event and may provide the user with force feedback for the writing pressure varying in real time.

The force feedback system 10 may be applied to various applications and programs that require providing of writing pressure according to a change in the contact event.

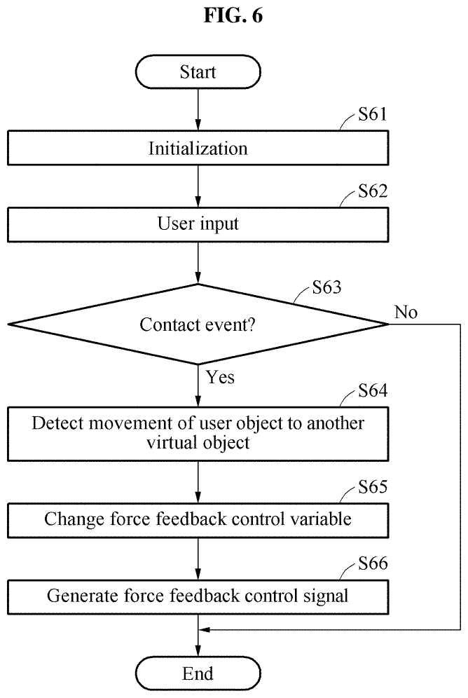

Hereinafter, a force feedback method using the force feedback system 10 according to an example embodiment will be described with reference to FIGS. 5 and 6.

FIG. 5 is a flowchart illustrating a force feedback method according to an example embodiment.

Referring to FIG. 5, the force feedback method includes an initialization operation S51, a user input operation S52, a contact event detecting operation S53, a force feedback control variable changing operation S54, and a force feedback control signal generating operation S55.

In the initialization operation S51, the extended reality provider 221 may load an application or a program, may generate a user object U and a virtual object V, may extract a control factor stored in the memory 230, and may apply the extracted control factor to user object data and virtual object data.

In the user input operation S52, the controller 220 detects an input that is input from a user to the input apparatus 100 and transfers the detected input data to the extended reality provider 221. The extended reality provider 221 receives the input data and generates an event corresponding to the input data.

In the contact event detecting operation S53, the contact event detector 222 determines whether an event corresponding to the input data is a contact event. Here, the contact event detector 222 generates contact event data that includes input data, user object data, and virtual object data. The contact event detector 222 further includes at least one of a progress direction, a moving speed, acceleration, a magnitude of force, and a direction of force according to the input of the user and transfers the contact event data to the control variable setter 223.

In the force feedback control variable changing operation S54, the control variable setter 223 changes a force feedback control variable based on the user object data, the virtual object data, and the contact event data. Here, the control variable setter 223 may change a force feedback control variable based on at least one of control factors including a magnitude of force, a contact angle, a contact area, a defect of a virtual object surface, a stiffness, a friction coefficient, and a viscosity. In detail, the control variable setter 223 may change the force feedback control variable based on at least one of a contact angle between the user object and the virtual object, a contact area between the user object and the virtual object, a contact area of the virtual substance, a stiffness of the user object, a stiffness of the virtual object, a friction coefficient of the user object, a stiffness of the virtual substance, a viscosity of the user object, a viscosity of the virtual object, a viscosity of the virtual substance between the user object and the virtual object, and a surface defect of the virtual object.

The control variable setter 223 sets a control variable based on a control method of the output apparatus 300. For example, when the control method of the output apparatus 300 is an impedance control method, the control variable setter 223 sets a control variable, for example, a spring constant k, a mass constant m, and an attenuation constant c, based on at least one of control factors including a magnitude of force, a contact angle, a contact area, a stiffness, a friction coefficient, and a viscosity. Also, the control variable setter 223 sets a direction and a magnitude of force feedback of the output apparatus 300 based on a progress direction, a moving speed, acceleration, a magnitude of force, and a direction of force.

In the force feedback control signal generating operation S55, the control variable setter 223 generates a force feedback control signal based on the force feedback control variable and transfers the control signal to the output apparatus 300 to output the force feedback.

Although not illustrated, the force feedback method may further include an operation of providing the user with an image that is updated in response to the contact event.

The force feedback method outputs the force feedback in real time by iteratively performing the aforementioned process.

FIG. 6 is a flowchart illustrating a force feedback method according to another example embodiment.

Referring to FIG. 6, the force feedback method includes an initialization operation S61, a user input operation S62, a contact event detecting operation S63, a movement-to-another virtual object detecting operation S64, a force feedback control variable changing operation S64, and a force feedback control signal generating operation S65.

Although not illustrated, the force feedback method may further include an operation of providing a user with an image that is updated in response to a contact event.

Here, the initialization operation S61, the user input operation S62, the contact event detecting operation S63, and the image providing operation include the same components as those in the force feedback method according to the example embodiment. Accordingly, a further description related thereto is omitted.

In the movement-to-another virtual object detecting operation S64, the user object U detects a contact event that the user object U moves from one virtual object V1 to another virtual object V2, V3. For example, the contact event may be changed in response to the user object U moving from the one virtual object V1 in which the contact event has occurred to the other virtual object V2, V3. The contact event detector 222 determines the changed contact event.

In the force feedback control variable changing operation S64, the control variable setter 223 changes a force feedback control variable based on the contact event between the user object and the other virtual object V2, V3. For example, the control variable setter 223 changes the force feedback control variable based on user object data, another virtual object data, and contact event data.

Here, the control variable setter 223 changes the force feedback control variable to instantaneously increase or decrease a writing pressure in a boundary between the one virtual object V1 and the other virtual object V2, V3 compared to the writing pressure in the other virtual object V2, V3, and changes again the force feedback control variable to maintain the writing pressure based on a control factor of the other virtual object V2. According to another example embodiment, the force feedback method may instantaneously increase or decrease the writing pressure in the boundary of the other virtual object such that the user may certainly recognize a change occurring in the boundary. In this manner, a sense of reality may be enhanced.

In the movement-to-other virtual object detecting operation S64, if the contact event that the user object moves from the one virtual object V1 to the other virtual object V2, V3 is not detected, the control variable setter 223 changes the force feedback control variable based on the contact event with the one virtual object V1.

In the force feedback control signal generating operation S65, the control variable setter 223 generates the force feedback control signal based on the force feedback control variable in real time, and transfers the generated control signal to the output apparatus 300 to output the force feedback in real time in response to a change in the event.

The force feedback method outputs the force feedback by iteratively performing the aforementioned process.

The force feedback method according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs,; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

Although a number of example embodiments have been described above, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

What is claimed is:

1. A force feedback method for writing pressure, the force feedback method comprising:
detecting occurrence of a contact event that a user object contacts a virtual object;
changing a force feedback control variable in response to the user object moving in the contact event; and
providing force feedback based on the changed control variable.

2. The force feedback method of claim 1, wherein the writing pressure is a sense for a repulsive force at a contact point by a pressing force of the user object and a moving force of the user object when the user object moves in contact with the virtual object.

3. The force feedback method of claim 2, wherein the changing of the force feedback control variable comprises changing the force feedback control variable based on at least one of control factors including a magnitude of force, a contact angle, a contact area, a defect of a virtual object surface, a stiffness, a friction coefficient, and a viscosity.

4. The force feedback method of claim 1, wherein the changing of the force feedback control variable comprises:
determining whether the user object moves from the virtual object to another virtual object; and
changing the force feedback control variable depending on whether the user object contacts the other virtual object.

5. The force feedback method of claim 4, wherein the changing of the force feedback control variable depending on whether the user object contacts with the other virtual object comprises:
changing the force feedback control variable to instantaneously increase or decrease a writing pressure in a boundary between the virtual object and the other virtual object compared to a writing pressure by the contact with the other virtual object; and
changing the force feedback control variable based on the writing pressure by the contact with the other virtual object.

6. The force feedback method of claim 1, further comprising:
receiving an input from a user;
wherein the user object is configured to move on an extended reality environment in response to the input of the user.

7. The force feedback method of claim 1, further comprising:
providing a user with an image that is updated in response to the contact event.

8. A force feedback method for writing pressure, the force feedback method comprising:
detecting occurrence of a contact event that a user object including a virtual substance contacts a virtual object based on the virtual substance present therebetween;
changing a force feedback control variable in response to the user object moving in the contact event; and
providing force feedback based on the changed control variable.

9. The force feedback method of claim 8, wherein the writing pressure is a sense for a repulsive force at a contact point by a pressing force of the user object and a moving force of the user object when the user object moves in contact with the virtual object.

10. The force feedback method of claim 9, wherein the changing of the force feedback control variable comprises changing the force feedback control variable based on at least one of control factors including a magnitude of force, a contact angle, a contact area, a defect of a virtual object surface, a stiffness, a friction coefficient, and a viscosity.

11. The force feedback method of claim 8, further comprising:
determining whether the user object moves from the virtual object to another virtual object,
wherein the changing of the force feedback control variable comprises changing the force feedback control variable to a force feedback control variable corresponding to a contact between the user object and the other virtual object.

12. The force feedback method of claim 11, wherein the changing of the force feedback control variable to the force feedback control variable corresponding to the contact between the user object and the other virtual object comprises:
changing the force feedback control variable to instantaneously increase or decrease a writing pressure in a boundary between the virtual object and the other virtual object compared to a writing pressure by the contact with the other virtual object; and
changing again the force feedback control variable based on the writing pressure by the contact with the other virtual object.

13. A force feedback system comprising:
a control apparatus configured to detect occurrence of a contact event that a user object contacts a virtual object, and to generate a force feedback control signal for a writing pressure by changing the force feedback control variable in response to movement of the user object; and
an output apparatus configured to receive the force feedback control signal and to provide a user with a sense for the writing pressure.

14. The force feedback system of claim 13, wherein the writing pressure is a sense for a repulsive force at a contact point by a pressing force of the user object and a moving force of the user object when the user object moves in contact with the virtual object.

15. The force feedback system of claim 14, wherein the control apparatus is configured to change the force feedback control variable based on at least one of control factors including a magnitude of force, a contact angle, a contact area, a defect of a virtual object surface, a stiffness, a friction coefficient, and a viscosity.

16. The force feedback system of claim 13, wherein a plurality of virtual objects is provided, and
the control apparatus is configured to change the force feedback control variable when the user object moves from a single virtual object to another virtual object among the plurality of virtual objects.

17. The force feedback system of claim 16, wherein the control apparatus is configured to instantaneously increase or decrease a magnitude of the writing pressure by changing the force feedback control variable in a boundary between the single virtual object and the other virtual object.

18. The force feedback system of claim 13, further comprising:
an input apparatus configured to detect an input of the user,
wherein the user object is configured to move on an extended reality environment in response to the input of the user.

19. The force feedback system of claim 13, further comprising:
a display apparatus configured to provide the user with an image that is updated in response to the contact event.
